(19) United States
(12) Patent Application Publication
(10) Pub. No.: US 2021/0200716 A1
(43) Pub. Date: Jul. 1, 2021

(54) PORTABLE SECURE DATA DELETION DEVICE AND METHOD FOR SECURE DATA DELETION

(71) Applicant: Shred Cube, LLC, Front Royal, VA (US)

(72) Inventors: Nancie Maria Gallegos WILLIAMS, Middletown, VA (US); Alexander Michael STIEB, Stephens City, VA (US)

(73) Assignee: Shred Cube, LLC, Front Royal, VA (US)

(21) Appl. No.: 16/727,128

(22) Filed: Dec. 26, 2019

(51) Int. Cl. G06F 16/16

(52) U.S. Cl. CPC G06F 16/162

(57) ABSTRACT

An apparatus and method for secure data deletion. The apparatus includes an enclosure, a connector for communicatively coupling to a computing device, a storage medium disposed within the enclosure and communicatively coupled to the connector, and self-contained software disposed on the storage medium. The software is configured to execute, on a processor, the steps of selecting for deletion files disposed on storage media accessible on the computing device, and performing a secure deletion action on the files. The software is further configured to execute the step of performing a deep scan for each file of the selected files. The deep scan includes canning storage media accessible on the computing device for files similar to the file, wherein files similar to the file are reformatted, duplicate, edited, changed, modified or similar files.

### BACKGROUND

Data stored on rewritable storage devices such as magnetic drives and solid-state (flash) media, as well as data stored in remote storage devices (commonly known as “the cloud”) is stored in data containers, or files. These files are organized by the file system of an operating system of a computer device, which tracks the physical location of the data on a particular storage medium, and enables user access to the data by referencing this physical location of the data to the actual data container with which the user can interact. While the physical locations of the data blocks may be contiguous or fragmented, depending on the needs of the operating system and the available storage space, the operating system will seamlessly present the data container as a unitary, user-operable object for ease of user interaction. To this end, the file system includes a directory catalog cross-referencing each data object with its corresponding data stored on the storage device.

Deletion of a data object in modern computer systems, from a user perspective, involves moving the data object to a trash container and then emptying this trash container, or executing a text command to delete a data object having a particular name and located in a particular directory. However, from the operating system perspective, only the file system reference between the data object and its corresponding data is deleted. In other words, the data object ceases to exist due to its identification and reference information being erased from the directory catalog, yet the actual data remains on the storage device. While the data may eventually be overwritten due to the operating system marking the physical locations where it is stored as free space, it does remain on the storage device for an indefinite duration. This duration is typically a non-trivial amount of time, especially as increasing storage device sizes provide ample space for new data to be written. During this time, the data may be recovered by recovery software or by an individual familiar with the functionality of the operating system and the file system. This presents a problem to users who wish to conclusively know that data from a deleted data object has been destroyed, especially when such data is sensitive or confidential.

Certain operating systems provide options to securely delete data by overwriting the data corresponding to a deleted data object. The data is typically overwritten with a certain pattern of bits, for example, all zeros, all ones, a random or pseudo-random sequence of zeroes and ones, and so forth. The data may be overwritten once or several times. However, this feature is not provided on all operating systems, especially when considering mobile devices and cloud-based storage, and many users may not know where to find and how to execute the appropriate actions and commands needed to perform a secure deletion. Furthermore, some users may wish to delete more a set of data objects fitting predetermined criteria. Furthermore, some users may wish to execute these actions with relative ease-of-use on several computers in succession. A portable, versatile, and easy to use solution for secure data deletion is therefore needed.

### SUMMARY

A portable secure data deletion device and method for secure data deletion. The device includes an enclosure, a connector for communicatively coupling to a computing device, a storage medium disposed within the enclosure and communicatively coupled to the connector, and self-contained software disposed on the storage medium. The software is configured to execute, on a processor, the steps of selecting for deletion files disposed on storage media accessible on the computing device, and performing a secure deletion action on the files. The software is further configured to execute the step of performing a deep scan for each file of the selected files. The deep scan includes canning storage media accessible on the computing device for files similar to the file, wherein files similar to the file are reformatted, duplicate, edited, changed, modified or similar files.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a diagram of an exemplary secure data deletion device.

FIG. 2 is an exemplary method for secure data deletion.

FIG. 3 shows an exemplary interface for a data deletion software.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

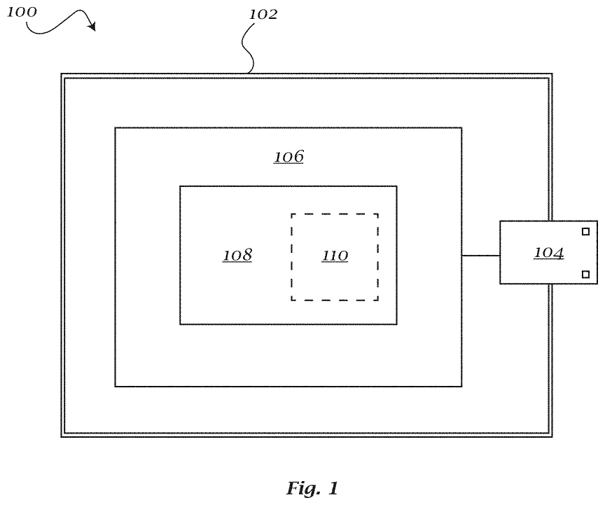

According to at least one exemplary embodiment, and as shown in FIG. 1, a secure data deletion device 100 is disclosed. The device can include an enclosure 102 and a connector 104 for interfacing with a desired computing device. Disposed within enclosure 102 may be a PCB 106 to which connector 104 may be communicatively coupled. Also coupled to PCB 106 may be a storage device 108, for example a non-volatile solid-state storage device. Other known components for PCB 106 and device 100, for example but not limited to a CPU and a memory, that enable device 100 to function as described herein may be contemplated and provided as desired.

Connector 104 may be, for example, a USB Type A or Type B connector, or any other known connector that enables device 100 to function as described herein, for example a USB Type C connector, a Lightning connector, and so forth. In other exemplary embodiments, a plurality of connectors for different standards may be simultaneously communicatively coupled to PCB 106, allowing the user to choose the appropriate connector for a desired computing device. In yet another exemplary embodiment, the plurality of connectors may be provided in a modular format. In such an embodiment each connector may be disconnectable and replaceable with another connector, and the connection between each connector 104 and PCB 106 may be easily coupleable and decouplable. Further, enclosure 102 and each connector 104 may include complementary coupling structures to facilitate secure coupling and ease of decoupling between the enclosure, the connector, and the PCB.

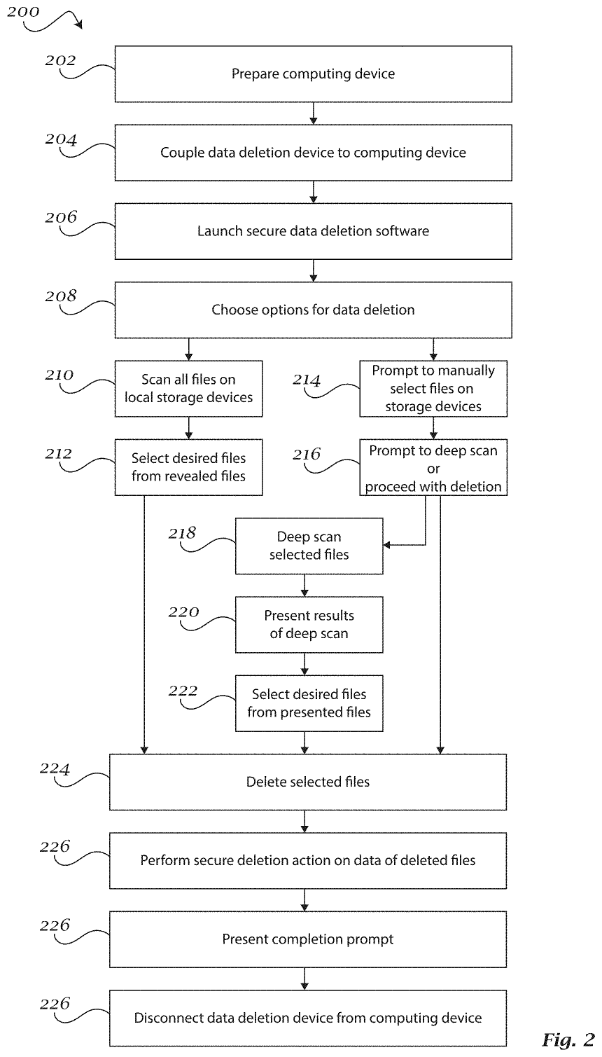

Stored on the storage device 108 may be software 110, operable by a CPU to execute the steps of the methods described herein. In an exemplary method for secure deletion 200, shown in FIG. 2, the user may utilize secure data deletion device 100 and software 110 to securely delete data on a desired computing device. The desired computing device may be a desktop or laptop computing device, or a portable device such as a phone or tablet. At step 202, the user may operate the desired computing device so as to place it in a state ready for coupling device 100. At step 204, the user may couple device 100 to the desired computing device. At step 206, the software stored on storage medium 108 may automatically launch or be launched by the user. An interface may be presented to the user at this step, with two or more options for proceeding with the secure file deletion. For example, the user may be presented with the options to choose desired files for secure deletion, to have software 110 scan the local storage devices of the computing device for all files accessible to the user given the user's permissions. At step 208, the user may choose one of the options presented by the interface, and the method may proceed according to the selected option.

If the user selects the option to scan local storage devices, the method can proceed with step 210, wherein the software will scan selected local storage devices for all file content. Following the scan, at step 212, the software can present an interface to the user to select particular files for secure deletion. Subsequent to this selection, the software can proceed to step 224, discussed further below.

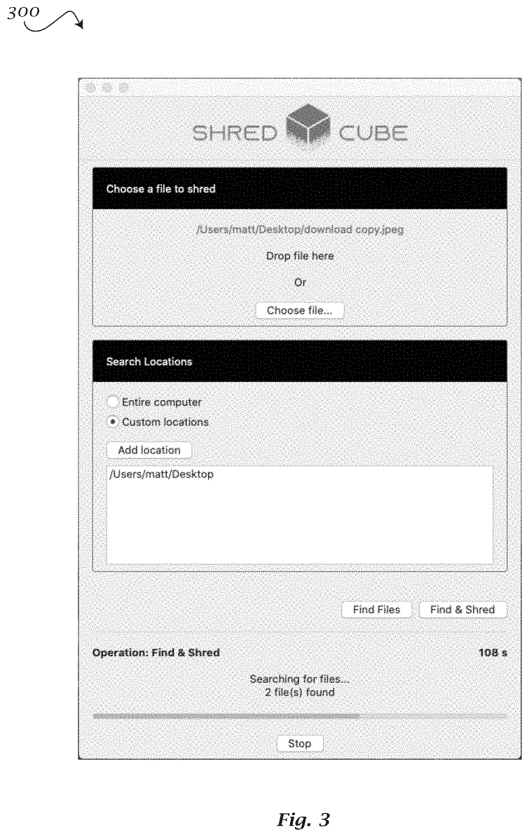

If the user selects the option to choose desired files, the method can proceed with step 214, wherein the user chooses the desired files via selection through dialog box, drag and drop, or any other desired interface for file selection. An exemplary interface for file scan and file selection is shown in FIG. 3. Once the files are chosen, at step 216, the software can prompt the user to perform a deep scan or to securely erase one or more individual files. If the user selects to securely erase one or more individual file, the software can proceed to step 224, discussed further below. If the user selects to perform a deep scan, the software can, at step 218, scan for reformatted, duplicate, edited, changed, modified, or similar file types within the selected files.

The software can perform a deep scan to find reformatted, duplicate, changed, edited, moved, modified or similar files. This can allow to find files that have been slightly modified, files that have multiple copies saved in multiple locations, as well as files having same or similar data but saved in a different file format. For example, a file may be backed up in a deeply-nested directory or on a drive, such as an external drive. The presence of such a file would not be readily obvious to a user. The deep scan may locate all storage devices connected to the computing device, and may scan all storage locations so as to find all accessible copies of a file, as well as files similar to the file, such as previous versions and revisions. The deep scan can also extend to connected remote drives, i.e., cloud storage, so as to find copies of a file and files similar to the file on the remote drive.

Subsequently, at step 220 the software can present the files revealed through this scan to the user for selection. At step 222, the user can select desired files, after which the software can proceed to step 224. At step 224, the software deletes the selected files from the storage device on which they reside by erasing references to the selected files from the file system. Subsequently, at step 226, the software performs a secure deletion action on the physical locations of the storage device where the data corresponding to the files was stored. The secure deletion action may be performed, for example, by overwriting the data with a pattern of bits, for example, all zeros, all ones, a random or pseudo-random sequence of zeroes and ones, or the like. In some exemplary embodiments, the secure deletion action may utilize a multi-pass random overwrite process. In further exemplary embodiments, the secure deletion action may utilize a DOD Standard 5250.22M algorithm and/or a Gutmann Algorithm. If the deletion process is to be performed on a cloud storage drive, the software can send a request to the cloud storage provider to delete the desired files. Once the secure deletion action is completed for all selected files, the software can present a completion prompt to the user at step 228. After completion, the user may choose to return the software to step 206 to repeat the secure deletion method. Alternatively, at step 230, the user may terminate software 110 and disconnect device 100 from the computing device.

Therefore disclosed herein is a portable and easy to use solution for secure file deletion that can be easily moved between computing devices and which can function independently of any particular operating system. To that end, storage 108 can have a partition that is compatible with a plurality of operating systems, and/or can include a plurality of partitions, with each partition being compatible with a particular operating system. Software 110 can further be self-contained on device 110 and not rely on any additional software or libraries located on the computing device. The self-containment of the software and the ability to disconnect secure deletion device 100 from the computing device additionally enhances security as it does not leave any portion of the secure deletion software 110 on the storage medium of the computing device, including file deletion logs, libraries, installation and uninstallation logs, registry entries, and so forth.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A secure data deletion device, comprising:
an enclosure;
a connector for communicatively coupling to a computing device;
a storage medium disposed within the enclosure and communicatively coupled to the connector;
self-contained software disposed on the storage medium and comprising instructions configured to execute, by a processor, the steps of selecting for deletion files disposed on storage media accessible on the computing device, and performing a secure deletion action on the files.

2. The device of claim 1, wherein the instructions are further configured to execute the steps of:
scanning all files disposed on storage media accessible on the computing device;
generating a scan result list of files; and
selecting desired files from the result list of files.

3. The device of claim 1, wherein the instructions are further configured to execute the steps of:
performing a deep scan for each file of the selected files, the deep scan comprising scanning storage media accessible on the computing device for files similar to the file, wherein files similar to the file comprise reformatted, duplicate, edited, changed, modified or similar files.

4. The device of claim 1, wherein the secure deletion action is a multi-pass random overwrite process.

5. The device of claim 1, wherein the secure deletion action is a DOD Standard 5250.22M algorithm.

6. The device of claim 1, wherein the secure deletion action is a Guttman algorithm.

7. The device of claim 1, wherein storage media accessible on the computing device comprise local storage media.

8. The device of claim 1, wherein storage media accessible on the computing device comprise cloud storage media.

9. A method for secure data deletion, comprising:
coupling a data deletion device to a computing device, the data deletion device comprising an enclosure, a connector for communicatively coupling the data deletion device to the computing device, and a storage medium on which a self-contained secure data deletion software is stored;
selecting for deletion files disposed on storage media accessible on the computing device;
performing a secure deletion action on the selected files; and
decoupling the secure data deletion device from the computing device.

10. The method of claim 9, wherein selecting files further comprises:
scanning all files disposed on storage media accessible on the computing device;
generating a scan result list of files; and
selecting desired files from the result list of files.

11. The method of claim 9, further comprising performing a deep scan for each file of the selected files, the deep scan comprising scanning storage media accessible on the computing device for files similar to the file, wherein files similar to the file comprise reformatted, duplicate, edited, changed, modified or similar files.

12. The method of claim 9, wherein the secure deletion action is a multi-pass random overwrite process.

13. The method of claim 9, wherein the secure deletion action is a DOD Standard 5250.22M algorithm.

14. The method of claim 9, wherein the secure deletion action is a Guttman algorithm.

15. The method of claim 9, wherein storage media accessible on the computing device comprise local storage media.

16. The method of claim 9, wherein storage media accessible on the computing device comprise cloud storage media.
